(19) United States
(12) Patent Application Publication
(10) Pub. No.: US 2017/0072747 A1
(43) Pub. Date: Mar. 16, 2017

(54) A CAP PLY REINFORCEMENT STRIP FOR PNEUMATIC TIRES

(71) Applicant: Kordsa Global Endüstriyel iplik ve Kord Bezi Sanay Sanayi ve Ticaret Anonim Sirketi, Kocaeli (TR)

(72) Inventors: Kürsat AKSOY, Kocaeli (TR); Evren GUNER, Kocaeli (TR); Ayse Hande TAMER, Kocaeli (TR); Sadettin FIDAN, Garbsen (DE)

(73) Assignee: Kordsa Global Endüstriyel iplik ve Kord Bezi Sanayi ve Ticaret Anonim Sirketi, Kocaeli (TR)

(21) Appl. No.: 15/309,209

(22) PCT Filed: May 6, 2015
(86) PCT No.: PCT/TR2015/000192

§ 371 Date: Nov. 7, 2016

(30) Foreign Application Priority Data
May 6, 2014 (TR) 2014/05069

(51) Int. Cl. B60C 9/18; B60C 9/22

(52) U.S. Cl. CPC B60C 9/1807; B60C 9/2204; B60C 2009/1814; B60C 2009/2035

(57) ABSTRACT

The present invention relates to a cap ply reinforcement strip in pneumatic tire (1) which is plain woven and comprised of warps (3) and texturized wefts (2). The inventive cap ply reinforcement strip in pneumatic tires (1) eliminates calendaring and strip preparation steps, enables to decrease the rolling resistance of the tire by eliminating the need for rubber coating and reduce the fuel consumption, tread wearing of the tire and braking distance.

### CROSS REFERENCE TO RELATED APPLICATIONS

This application is a national phase entry application of International Application No. PCT/TR2015/000192, filed on May 6 2015, which is based upon and claims priority to NO. TR2014/05069, filed on May 6, 2014, the entire contents of which are incorporated herein by reference.

### TECHNICAL FIELD

The present invention relates to a cap ply reinforcement strip which is ready to use plain woven, which is comprised of cord or twisted yarns as warp and yarn with high linear density as weft, and which is in direct contact with the tread rubber in pneumatic radial tires.

### BACKGROUND

In radial tires, it is known that the cap ply reinforcement strip, which is wound on the belt package by making a small angle with the equatorial plane in order to form a cap ply, improves performance of the radial tire especially at high speeds.

Winding nylon 6.6, PET (polyethylene terephthalate), hybrid (Aramide+Nylon 5.5, Aramide+PET) cords spirally as cap ply reinforcement layer on the belt package as strips has been applied for many years by several tire companies in order to improve high speed durability and handling performance in pneumatic radial tires. The cord strips are obtained by cutting calendered (rubberized) cord fabric in strips or rubberizing parallel single cords in a certain width during extrusion process without

In current embodiments, well yarns with low linear density (100-300 dtex) which do not have any effect on tire performance in cap ply reinforcement strips are used and the only purpose for using these is to hold the warp yarns or cords together as parallel to each other.

WO2012/063180 is also known in the prior art.

The wefts having higher linear density used in sonic embodiments do not have any effect on the tire performance due to not being able to form any elevation or protrusion on the strip surface since they remain between the leno woven warps(U.S. Pat. No. 7,252,129). Wefts are not used at all in cap ply reinforcement strips prepared with extrusion process.

### SUMMARY OF THE INVENTION

The objective of the present invention is to provide a cap ply reinforcement strip which is obtained by plain weaving the warps with the texturized well yarns with high linear density for pneumatic radial tires.

Another objective of the present invention is to provide a cap ply reinforcement strip which reduces the tread wearing, rolling resistance and braking distance of the pneumatic radial tire by means of the well yarns comprised therein.

### BRIEF DESCRIPTION OF THE DRAWINGS

“Cap ply reinforcement strip for pneumatic tires” developed to fulfill the objective of the present invention is illustrated in the accompanying figures wherein,

FIG. 1 is the zoomed, top view of the cap ply reinforcement strip.

FIG. 2 is the deformation direction of the tire it in time of contact with the road in a moving vehicle and the resistance of the weft yarns against this deformation.

FIG. 3 is the deformation direction of the tire tread in time of contact with the road in a braking vehicle and the resistance of the weft yarns against this deformation.

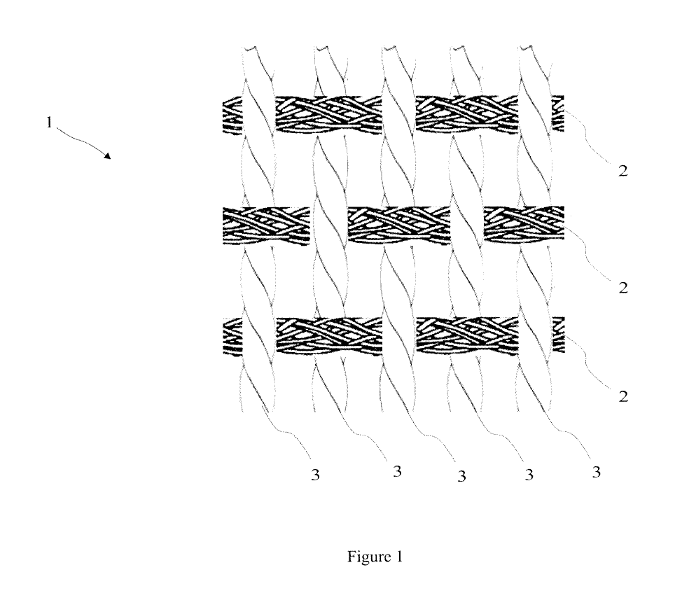

The components given in the figure are numbered and the numbers refer to the following:
1. Cap ply reinforcement strip
2. Weft yarn
3. Warp
A direction of vehicle's movement
L. Direction of tire's rotation.
D. Direction of tread's deformation

### DETAILED DESCRIPTION OF THE INVENTION

Inventive cap ply reinforcement strip (1) comprises
a plurality of texturized weft yarns (2) parallel to each other the linear density of which changes between 1400 and 6000 dtex, and
a plurality of warps (3) parallel to each other which are fixed to weft)yarns (2) by being plain woven such that they will form a right angle on horizontal plane to the weft yarns.

Inventive cap ply reinforcement strip (1) is wound on the belt package on the tire spirally such that there will be a 0 to 5° degree angle with equatorial plane of the tire and it is in direct contact with the tread rubber.

Inventive cap ply reinforcement strip (1), which eliminates calendaring and strip preparing stages and enables to reduce rolling resistance of the tire and the fuel consumption by avoiding the requirement for rubber coating thereon, comprises an adhesive dip on its outer surface that is required for tire production process.

In the preferred embodiment of the invention, well yarns (2) and the warps are fixed to each other with adhesive clipping material, and thus a strong bond is formed on contact points of weft yarn (2) and warps (3) and warp (3) in strip (1) is prevented from shifting aside and separating. The adhesive material used in one embodiment of the invention is RFL (Resorcinol Formaldehyde Latex).

In one embodiment of the invention, well yarns (2) and warps (3) are adhered to each other with dipping process for preparing cap ply reinforcement strip (1), and then strip (1) is optionally cemented with rubber solution, and the physical adherence of its surface is improved.

Well yarns (2) in plain woven cap ply reinforcement strip (1) form regular elevations at contact points with warps (3) on the lower and upper surfaces of strip (1). These weft elevations are embedded into the tread rubber in the tire and thus increase the resistance of the tread against deformation.

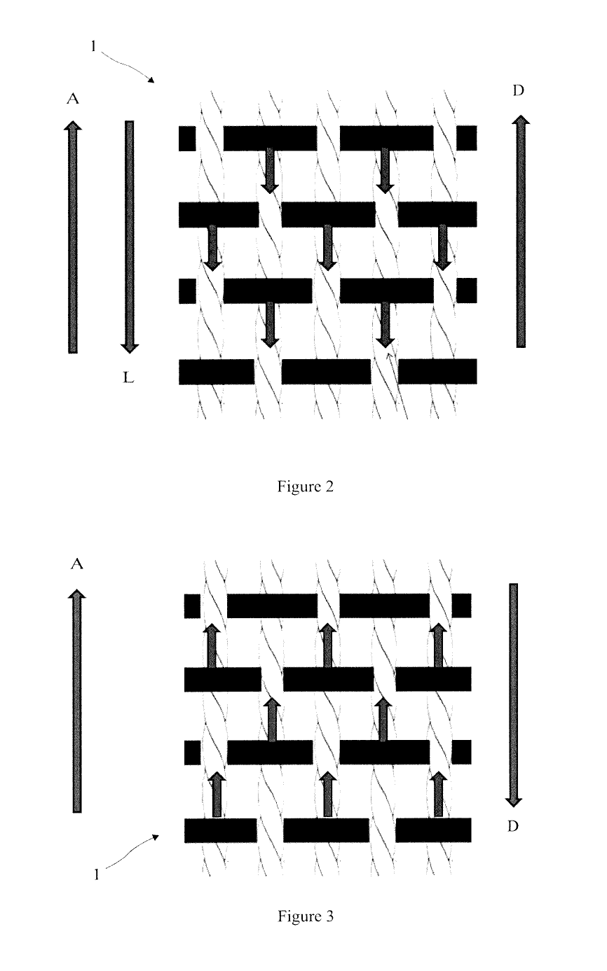

Since the improved resistance of tread area against deformation increases the efficiency of force transfer between the road surface and the tire, it reduces the rolling resistance and tread wearing of the tire (FIG. 2). On the other hand, in case a vehicle moving at high speed brakes, due to the effective force transfer between the road surface and the tire in which inventive cap ply reinforcement strip (1) is used, the vehicle can stop in shorter distance than normal. This is a factor which increases the safety of the vehicle (FIG. 3).

Texturized weft yarns (2) absorb the adhesive material more easily due to their texturized structure, this increases the resistance and stability of cap ply reinforcement strip (1) in the tire under dynamic conditions. Another advantage provided with inventive cap ply reinforcement strip (1) is that the noise originating from the tread deformation is reduced. In case of using texturized weft yarns, the amount of the adhesive dip in the cap ply reinforcement strip is between 5% to 80%, preferably 8% to 40 or more preferably 10% to 25%.

Aside from chemical adhesion, mechanical interlocking between cap ply reinforcement strip (1) and the tread formed by the weft elevations prevents the tread from separating from cap ply reinforcement strip (1) at high speeds. This especially has great importance for radial aircraft tire.

The width of inventive cap ply reinforcement strip (1) varies between 5 to 30 mm, preferably 8 to 15 mm. The number of warps (3) present in the 10 mm width of cap ply reinforcement strip (1) may vary between 3 to 20. The cord twist degrees of warps (3) are between 100 to 800 twist/meter (tpm) preferably 250 to 350 tpm.

Warps (3) used in inventive cap ply reinforcement strip (1) can be comprised of hybrid cords such as PET-nylon 6.6, aramide-nylon 6.6 or aramide-PET as well as it can be comprised of nylon 6.6, PET (polyethylene terephthalate), aramide cords.

The cords used in warps (3) can comprise 2 to 7 nylon 6.6, PET or monofilaments of both the diameters of which are 0.1 to 1 mm.

Weft yarns (2) are manufactured from at least one material selected from the group comprising nylon 6.6, nylon 4.6, nylon 6, PET (polyethylene terephthalate), PEN (polyethylene naphthalate) or rayon.

The linear densities of weft yarns (2) can vary between 1400 to 6000 dtex, preferably 1400 to 3000 dtex. Weft yarns (2) used as weft can be twisted or non-twisted. The number of texturized weft yarns (2) in 10 cm long strip (1) can be 5 to 50, preferably 10 to 20.

1. A cap ply reinforcement strip (1), which enables to reduce braking distance and tread wearing as well as improving high speed durability in pneumatic radial tires, comprising
a plurality of texturized weft yarns (2) parallel to each other the linear density of which changes between 1400 and 6000 dtex, and
a plurality of warp yarns (3) parallel to each other which are fixed to weft yarns (2) by being plain woven such that they will form an angle between 80 and 100° on horizontal plane with well yarns, and characterized in that it is wound on the belt package in the tire spirally such that it will have 0 to 5° degrees with the equatorial plane and it is in direct contact with the tread rubber.

2. A cap ply reinforcement strip (1) according to claim 1, characterized in that texturized weft yarns (2) and the warp yarns (3) are fixed to each other with an adhesive dipping material, and thus a strong bond is formed at the contact points of the weft yarns (2) and the warp yarns (3), the warp yarns (3) are prevented from shifting aside and separating.

3. A cap ply reinforcement strip (1) according to claim 2, characterized in that the adhesive material which is used is RFL (Resorcinol Formaldehyde Latex).

4. A cap ply reinforcement strip (1) according to any one of the claim 2 or 3, characterized in that it comprises an adhesive material in amount of between 5% to 80%, preferably 8% to 40 or more preferably 10% to 25% by weight.

5. A cap ply reinforcement strip (1) according to any one of the claims 2 to 4, characterized in that strip (1) is cemented with rubber solution and thus the physical adhesiveness of its surface is improved after the texturized weft yarns (2) and the warp yarns (3) are adhered to each other.

6. A cap ply reinforcement strip (1) according to any one of the preceding claims, characterized in that the texturized weft yarns (2) forms regular elevations at contact points with warp yarns (3) on the lower and upper surfaces of the strip (1) and these weft elevations are embedded into the tread rubber in the tire and thus increases the resistance of the tread against deformation.

7. A cap ply reinforcement strip (1) according to claim 6, characterized in that the force transfer efficiency between the road surface and the tire increases and the rolling resistance and the tread wearing of the tire reduces by means of the weft elevations embedded into the tread rubber.

8. A cap ply reinforcement strip (1) according to any one of the preceding claims, characterized in that its width is between 5 to 30 mm.

9. A cap ply reinforcement strip (1) according to claim 8, characterized in that its width is between 8 to 15 mm.

10. A cap ply reinforcement strip (1) according to any one of the claim 8 or 9, characterized in that it comprises warp yarn (3) in number of 3 to 20 having width of 10 mm.

11. A cap ply reinforcement strip (1) according to any one of the preceding claims, characterized by warp (2) the cord twisting degree of which is between 100 and 800 twist/meter (tpm).

12. A cap ply reinforcement strip (1) according to claim 11, characterized by warp (3) the cord twisting degree of which is between 250 and 350 tpm.

13. A cap ply reinforcement strip (1) according to any one of the preceding claims, characterized by texturized weft yarns (2) the linear density of which is between 1400 to 6000 dtex.

14. A cap ply reinforcement strip (1) according to claim 13 characterized by texturized weft yarns (2) the linear density of which is between 1400 to 3000 dtex.

15. A cap ply reinforcement strip (1) according to any one of the preceding claims, characterized by texturized weft yarn (2) which is manufactured from at least one material selected from the group comprising nylon 6.6, nylon 4.6, nylon 6, PET (polyethylene terephthalate), PEN (polyethylene naphthalate) or rayon.

16. A cap ply reinforcement strip (1) according to any one of the preceding claims, characterized by texturized weft yarns (2) the number of which is 5 to 50 in a strip (1) having the length of 10 cm.

17. A cap ply reinforcement strip (1) according to any one of the preceding claims, characterized by warp yarns (3) which are comprised of nylon 6.6, PET (polyethylene terephthalate), aramide cords or hybrid cords such as PET-nylon 6.6, aramide-nylon 6.6 or aramide-PET.

18. A cap ply reinforcement strip (1) according to claim 17, characterized by warps (3) which comprise monofilaments foamed of 2 to 7 nylon 6.6, PET or both, the diameters of which vary between 0.1 to 1 mm.
